(19) United States
(12) Patent Application Publication
(10) Pub. No.: US 2025/0375846 A1
(43) Pub. Date: Dec. 11, 2025

(54) SYSTEMS AND METHODS FOR ABRADING A REFLECTIVE WORKSURFACE

(71) Applicant: 3M INNOVATIVE PROPERTIES COMPANY, St. Paul, MN (US)

(72) Inventors: Joseph B. Eckel, Vadnais Heights, MN (US); Aaron K. Nienaber, Lake Almo, MN (US); Brittany J. Moren, Cottage Grove, MN (US); Mark W. Orlando, Chesterfield Township, MI (US); Daniel M. Bodily, Woodbury, MN (US); Nathan J. Herbst, Woodbury, MN (US); Alireza Ghaderi, Woodbury, MN (US); Grayce T. Huberty, Cottage Grove, MN (US)

(21) Appl. No.: 18/876,827

(22) PCT Filed: Jun. 29, 2023
(86) PCT No.: PCT/IB2023/056788

§ 371 Date: Dec. 19, 2024

Related U.S. Application Data
(60) Provisional application No. 63/367,489, filed on Jul. 1, 2022.

(51) Int. Cl. B24B 7/22

(52) U.S. Cl. CPC B24B 7/22

(57) ABSTRACT

A surface abrading system is presented that includes a robot arm with an end effector on an end of the robot arm. The end effector is configured to couple to an abrasive article. The system also includes a movement mechanism that moves the robot arm with respect to a surface. The system also includes a robot controller that causes the robot arm to execute an abrasive trajectory on the surface. The abrasive trajectory includes the abrasive article in contact with the surface. The robot controller includes a trajectory retriever that retrieves an abrasive trajectory. The abrasive trajectory includes a surface appearance portion prior to an endpoint. The surface appearance portion comprises a reduction in relative movement speed between the robot arm and the abrasive article or a reduction in effective applied force on the abrasive article. The controller also includes a command generator that communicates the abrasive trajectory to the movement mechanism to execute the trajectory.

### BACKGROUND

Clear coat repair is one of the last operations to be automated in the automotive original equipment manufacturing (OEM) sector. Defect repair presents many challenges for automation. Reflective materials present unique challenges for automation.

### SUMMARY

A surface abrading system is presented that includes a robot arm with an end effector on an end of the robot arm. The end effector is configured to couple to an abrasive article. The system also includes a movement mechanism that moves the robot arm with respect to a surface. The system also includes a robot controller that causes the robot arm to execute an abrasive trajectory on the surface. The abrasive trajectory includes the abrasive article in contact with the surface. The robot controller includes a trajectory retriever that retrieves an abrasive trajectory. The abrasive trajectory includes a surface appearance portion prior to an endpoint. The surface appearance portion comprises a reduction in relative movement speed between the robot arm and the abrasive article or a reduction in effective applied force on the abrasive article. The controller also includes a command generator that communicates the abrasive trajectory to the movement mechanism to execute the trajectory.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a schematic of a robotic surface processing system in which embodiments of the present invention are useful.

FIGS. 2A-2D illustrate defects that may be introduced during the clear coat repair process.

FIGS. 3A-3B are schematics illustrating a surface processing operation in which embodiments herein may be implemented.

FIGS. 4A-4C illustrate a line-scan array imaging system for a curved surface

FIGS. 5A-5B illustrate process parameter for, and results of, abrading operations as described herein.

FIG. 6 illustrates a schematic for a surface processing operation in accordance with embodiments herein.

FIG. 7 illustrates a method of modifying a repair solution in accordance with embodiments herein.

FIG. 8 illustrates a method of abrading a surface in accordance with embodiments herein.

FIG. 9 illustrates a robotic abrading system in accordance with embodiments herein.

FIG. 10 is a robotic abrading system architecture.

FIGS. 11-12 show examples of computing devices that can be used in embodiments shown in previous Figures.

### DETAILED DESCRIPTION

Recent advancements in imaging technology and computational systems have made feasible the process of clear coat defect inspection repair at production speeds. In particular, stereo deflectometry has recently been shown to be capable of providing images and locations of paint and clear coat defects at appropriate resolution with spatial information (providing coordinate location information and defect classification) to allow subsequent automated spot repair. As automated imaging of worksurfaces improves, it is equally desired to improve the ability to automatically process worksurfaces. For example, in the case of clear coat repair, it is desired to repair detected defects, using a robotic repair system, with as little manual intervention as possible.

However, as discussed herein, one problem with automation is the precision with which robotic systems execute repair trajectories, starting and ending in very proscribed locations. Human operators rarely duplicate the exact same repair motion, which results in some randomness that is hard to replicate in robotic systems. That random action, particularly during the end of a repair, often results in a more desirable final appearance.

Robotic applications are often utilizing servo motors which offer a higher opportunity for speed control, acceleration and deceleration rates, and the ability to maintain set point speeds regardless of the amount of force being applied. Tools that utilize pneumatics and even many battery powered and electric tools for these applications do not have the ability to independently control these parameters. It is therefore important to find a way to use the higher control and efficiency of robotic applications to reproduce the aesthetic affects that human operators achieve.

As used herein, the term “vehicle” is intended to cover a broad range of mobile structures that receive at least one coat of paint or clear coat during manufacturing. While many examples herein concern automobiles, it is expressly contemplated that methods and systems described herein are also applicable to trucks, trains, boats (with or without motors), airplanes, helicopters, etc. Additionally, while vehicles are described as examples where embodiments herein are particularly useful, it is expressly contemplated that some systems and methods herein may apply to surface processing in other industries, such as painting, adhesive processing, or material removal, such as sanding or polishing wood, plastic, paint, etc.

The term “paint” is used herein to refer broadly to any of the various layers of e-coat, filler, primer, paint, clear coat, etc. of the vehicle that have been applied in the finishing process. Additionally, the term “paint repair” involves locating and repairing any visual artifacts (defects) on or within any of the paint layers. In some embodiments, systems and methods described herein use clear coat as the target paint repair layer. However, the systems and methods presented apply to any particular paint layer (e-coat, filler, primer, paint, clear coat, etc.) with little to no modification

As used herein, the term “defect” refers to an area on a worksurface that interrupts the visual aesthetic. For example, many vehicles appear shiny or metallic after painting is completed. A “defect” can include debris trapped within one or more of the various paint layers on the work surface. Defects can also include smudges in the paint, excess paint including smears or dripping, as well as dents.

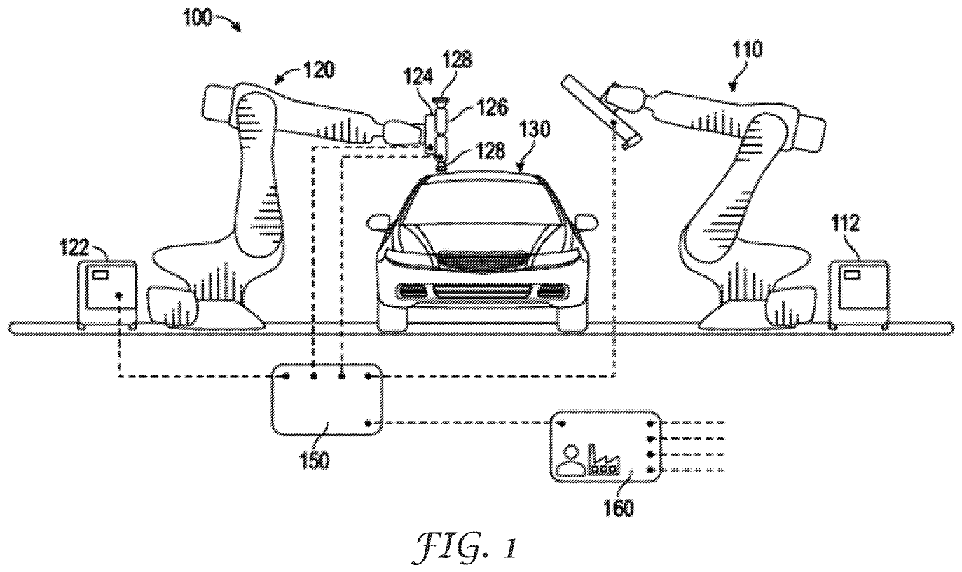

FIG. 1 is a schematic of a robotic paint repair system in which embodiments of the present invention are useful. System 100 generally includes two units, a visual inspection system 110 and a defect repair system 120. Both systems may be controlled by a motion controller 112, 122, respectively, which may receive instructions from one or more application controllers 150. The application controller may receive input, or provide output, to a user interface 160. Repair unit 120 includes a force control unit 124 that can be aligned with an end-effector 126. As illustrated in FIG. 1, end effector 126 includes two processing tools 128. However, other arrangements are also expressly contemplated.

The current state of the art in vehicle paint repair is to use fine abrasive and/or polish systems to manually sand/polish out the defects, with or without the aid of a power tool, while maintaining the desirable finish (e.g., matching specularity in the clear coat). An expert human executing such a repair leverages many hours of training while simultaneously utilizing their senses to monitor the progress of the repair and make changes accordingly. Such sophisticated behavior is hard to capture in a robotic solution with limited sensing.

Additionally, abrasive material removal is a pressure driven process while many industrial manipulators, in general, operate natively in the position tracking/control regime and are optimized with positional precision in mind. The result is extremely precise systems with extremely stiff error response curves (i.e., small positional displacements result in very large corrective forces) that are inherently bad at effort control (i.e., joint torque and/or Cartesian force)). Closed-loop force control approaches have been used (with limited utility) to address the latter along with more recent (and more successful) force controlled flanges that provide a soft (i.e., not stiff) displacement curve much more amenable to sensitive force/pressure-driven processing. The problem of robust process strategy/control, however, remains and is the focus of this work.

As described herein, post-repair inspection may take place substantially immediately after a repair, for example using an imaging system mounted in a tool position 128, opposite an abrasive repair tool in an opposing tool position 128. In other embodiments, post-repair inspection may be done by a second imaging system mounted on robotic unit 110, such that pre-repair and post-repair imaging are conducted by the same imaging system or, for example, one of a dual-mounted imaging system. In yet other embodiments, post-repair imaging is done by a third robotic system (not shown in FIG. 1).

Additionally, while systems and methods herein are discussed in a post-repair context, it is expressly contemplated that they could also be used in a pre-inspection context, for example to inform a defect repair process. For example, a global inspection may be conducted on vehicle 130, by inspection system 110 or systems described herein, to identify defect locations and types. Then a second pass may be done, either by the same or different system, to obtain a different or higher resolution image of a defect, or more precise location information. The second pass may be used to provide additional feedback for a defect repair system 100, e.g. changing the polishing step from 3 seconds to 5 seconds. In other embodiments, the second pass, or a third pass, is done after a repair to confirm that a defect has been repaired, and to understand how the repair has changed the surface-orange peel removal, introduction of haze or scratches, etc.

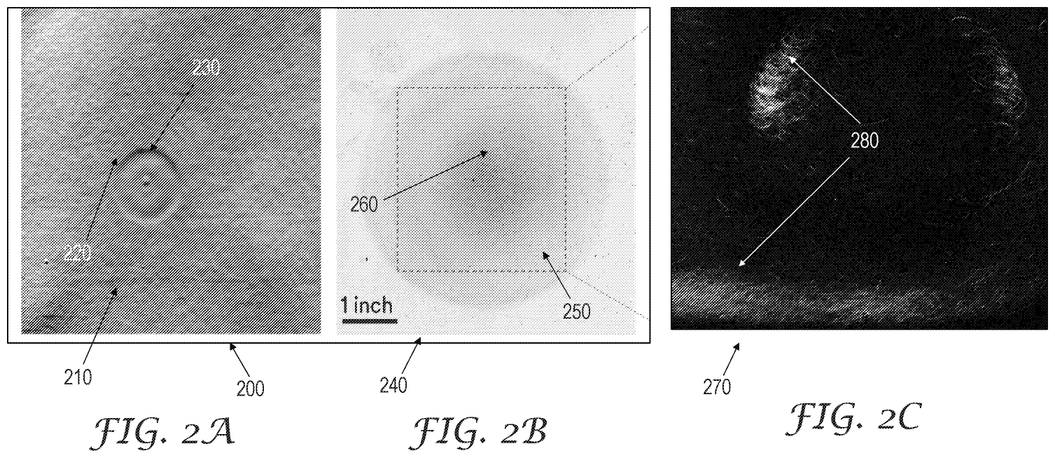

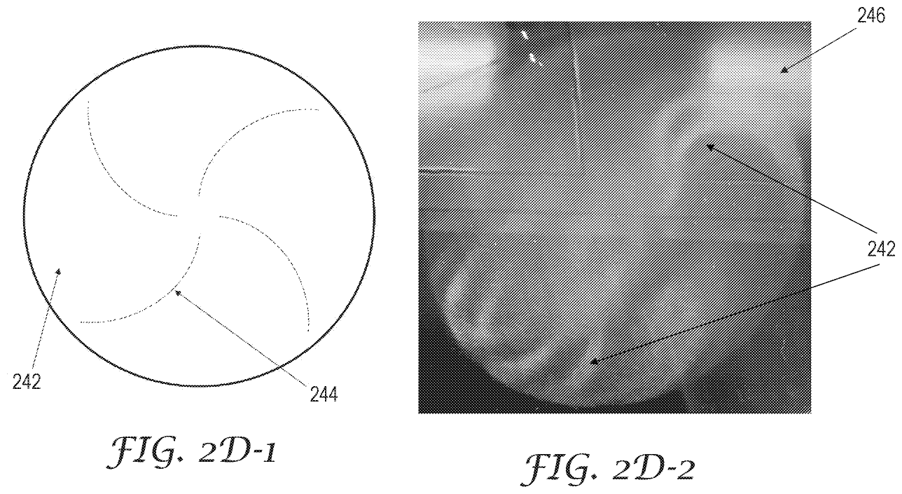

FIGS. 2A-2C illustrate defects that may be introduced during the clear coat repair process. FIGS. 2A-2C illustrate some example images of surface, taken after a repair. In automated robotic paint finishing, paint defects are sanded out with a sanding disc. This removes the defect but introduces scratches into the surface. These sanding scratches are removed via a buffing step with polishing compound. However, the buffing step can introduce very fine scratches into the surface that are seen in certain light angles as haze. Haze may not be visible in every angle, but it is considered to be an undesirable surface appearance by customers and, therefore, should be reduced or avoided if possible.

Additionally, a pinwheeling effect is also seen in robotic abrading context. It is known that the particular haze defect, often called a “pinwheel” or “hologram” (shown in FIG. 2D-2) that is sometimes seen after a buffing process on a clear coat surface is due to the formation of micro scratches on the surface.

Paint defects that form during painting process are often removed using abrasive media. However, the surface texture can be changed or ‘damaged’ during the abrasive process, which may change in the appearance of the repair area. Although the aim of the polishing process is to remove all sanding scratches and return the specular surface, micro scale scratches may be introduced that cause a haziness appearance on the surface.

FIGS. 2A-2D illustrate post-repair images of defects that can be introduced during the repair process. Some can be addressed by changing trajectory, e.g. as in U.S. Provisional patent application Ser. No. 17/756,444 Filed Nov. 24, 2020. Others can be addressed by additional post-repair steps.

FIG. 2A illustrates a post-repair image 200 of a surface. The surface has texture 210, referred to as “orange peel” because the consistency is similar to the surface of an orange fruit. A repair area 220 includes a repaired defect 230. Repairing a defect may not necessarily entail complete removal of the defect, in some instances, but may include grinding down the defect so that the surface is smooth, or otherwise altering the defect so that it is less visible. As illustrated in FIG. 2A, a clear perimeter of repair area 220 is visible, and may be visible to the human eye, which is undesirable. It is desired to repair a defect area 220 without a clear interruption of orange peel texture 210.

FIG. 2B illustrates haze on a repaired surface 240. As illustrated in FIG. 2B, haze may not be consistent across a surface, in fact, it is often higher in one area 260 of a repair area than in another area 250, creating a “bulls-eye” appearance. The repair trajectory used on surface 240 ended in area 260, which is why the “bulls-eye” is located there. Based on the image provided in 240, the haze value can be quantified. For example, the average haze value, H, over the whole repaired area can be estimated as H=(1−(Li/255))×100, where Li is the mean light intensity value of the repaired area. The haze appearance for spot repairs with H<˜13 is not visible with the human eye.

FIG. 2C illustrates a processed image of a repaired surface 270 that reveals scratches 280 introduced to a surface during the repair process.

Defect repair generally includes first abrading the surface with a first abrasive article, e.g. a sanding pad, before abrading the surface with a second abrasive article, e.g. a polishing or buffing pad, impregnated with an abrasive compound—e.g. polish or abrasive particles. The first abrasive article is used to rapidly reduce a height of a defect or to rapidly remove material. The coarseness of the abrasive particles in the article usually dictate the material removal rate. Generally, the higher material removal rate, the coarser the scratches left behind afterwards. So a second, less aggressive abrasive media (e.g. a buffing pad containing polish compound) is used to polish the surface and remove the scratches caused by the first abrasive article. However, as illustrated in FIG. 2B, the polishing process removes scratches by abrading, which can leave behind many microscratches that form a hazy appearance. In robotic processes, this can also create a gradient in the color of haze, with a darker area where the abrasive trajectory ends.

FIGS. 2D-1 and 2D-2 illustrate a “pinwheel” or “hologram” haze pattern that can also result from the polishing step. Microscratches can reduce the surface specularity by scattering the light reflections and cause the surface to appear hazy. It has been found that the haze appearance might be formed in a specific pattern and becomes even more noticeable once an automated buffing tool is used. In manual operation, when the buffing process is carried out by human, the direction of the fine scratches is almost random. However, in an automated process-using a simple trajectory (like a spiral), the scratches are aligned with the spiral trajectory program used. This might be explained by the fact that the buffing tool mounted on a robotic arm precisely follows a predefined perfect geometric pathway that increases the chance of scratch formation in specific directions. The pinwheel haze pattern can be clearly observed while we turn an illuminated light around the surface or rotate the panel under a fixed light.

However, other patterns may also have micro-scratch patterns that align with repair geometry. For example, a back-and-forth repair pattern may also result in a haze pattern that aligns with that patten.

FIG. 2D-1 illustrates a schematic of a buffed area 242 with pinwheel lines 244, and FIG. 2D-2 illustrates buffed area 246 with pinwheel lines 242. Such defects are often called “hologram” defects because the pinwheel lines 242 appear to move, like a simple hologram, as a viewer shifts their perspective. In direct sunlight, general haze can be difficult to see, but the “pin-wheel” haze can be highly visible.

Haze is generally an unacceptable surface appearance for most customers. Therefore, it is desired to find systems and methods that can reduce the appearance of haze, both the “bulls-eye” haze of FIG. 2B and the “pin-wheel” haze (or other patterns correlating with the programmed trajectory) of FIG. 2D.

Haze can be reduced by reducing the aggressiveness of the polishing or buffing step. However, this usually requires the use of a less aggressive polishing pad and/or polishing compound. In turn, this less aggressive polishing can take considerably longer time to fully remove the sanding scratches from the previous repair step. Since most vehicles have multiple defects needing repair, increasing the per-defect cycle time even a small amount has a large effect on the overall per-vehicle repair time and reduces the number of vehicles that can be repaired per shift. In addition, increasing polishing times can increase the internal temperature of the polishing pad, which can reduce the lifespan of the pad. A solution is desired that allows for adequate removal of the sanding scratches, a minimum level of haze, but does not significantly increase cycle time or reduce the life of the polishing pad.

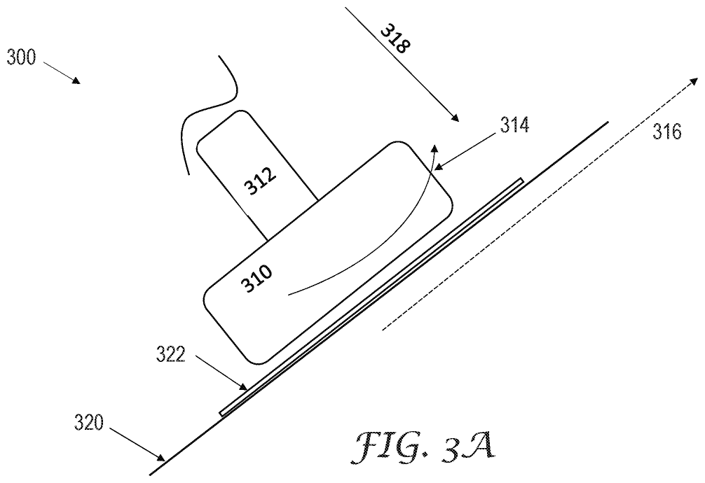

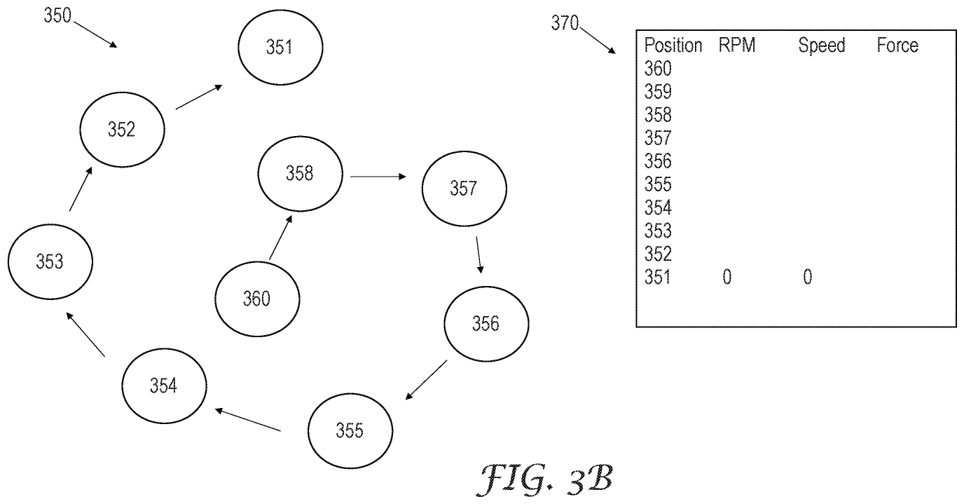

FIGS. 3A-3B are schematics illustrating a surface processing operation in which embodiments herein may be implemented. FIGS. 3A-3B illustrate a simplified schematic of an abrasive article 310 moving along a flat surface 320 along a path 316. Polishing compound 322 is illustrated as deposited on surface 320. However, it is expressly noted that, for many repair operations, particularly for automobile repair, the surface has curvature and a robotic abrading unit (not shown in FIG. 3A), using spindle 312, moves abrading unit 310 along surface 320. A force 318 is applied against abrasive article 310, by a force control unit of the robotic abrading system, for example, urging abrasive article 310 against surface 320. In some embodiments, abrasive article 310 is also rotating, for example as a simple orbital rotation, a random orbital rotation, vibration, or another movement pattern.

FIG. 3B illustrates a very simple spiral trajectory 350 with nine waypoints on a spiral path. This is for illustrative purposes only, and it is expressly contemplated that other trajectories (linear, orbital, figure-eight, rose, hypotrochoid or any other suitable path shape).

In the illustrated example, the path starts with a touchdown at point 360, where abrasive article 310 contacts a surface. As illustrated in chart 370, at each point 359-351, abrasive article 310 has a rotational speed, a movement speed (e.g. from 352 toward 351) and an applied force urging abrasive article 310 into contact with a surface 320.

As illustrated in chart 370, a number of parameters may change along a path 350. As used herein, the term “trajectory” refers to the time-parametrized path along waypoints 360 toward 351. At each point on the trajectory, the abrasive article is moving at a speed, with an applied force against a surface, and with a rotational (or orbital or random orbital or vibrational) speed.

When the repair trajectory comes to an end the robotic arm traditionally decelerates as it approaches point 351 or in place at point 360. It is believed that this rotation in a fixed position causes the problematic haze.

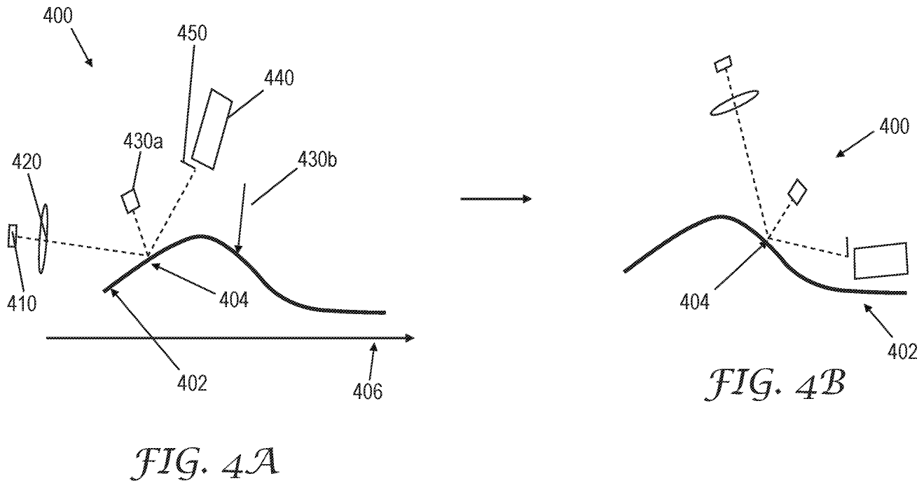

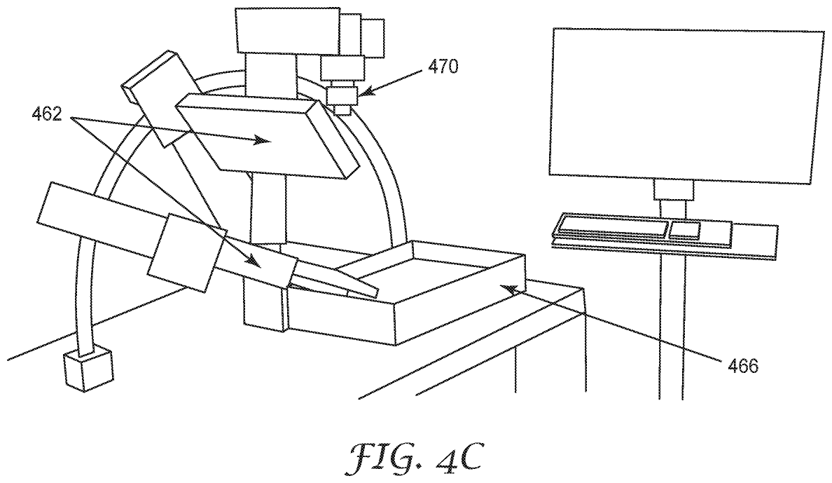

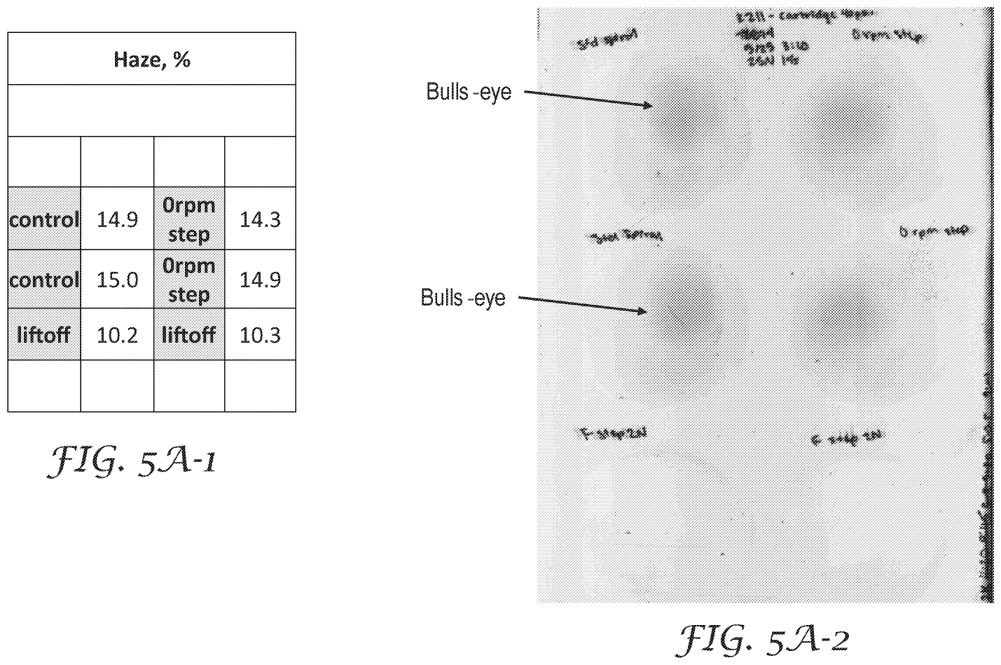

FIGS. 4A-4C illustrate a line-scan array imaging system for a curved surface. In order to quantify and understand haze, an imaging system is used to capture the haze. Imaging on reflective surfaces presents challenges from glare, and imaging on a curved surface also presents challenges because of the changing distance.

However, while FIGS. 4A-4C illustrate one system that can be used to image haze, it is expressly contemplated that other suitable systems may also be used. Additionally, it is also expressly contemplated that systems and methods herein may be implemented in robotic repair systems without vision systems, or without feedback from a vision system. For example, a haze-reducing trajectory may be selected for any surface repair of a defect in a location visible to a customer (e.g. on a hood).

FIGS. 4A-4C illustrate a line-scan array imaging system for a curved surface. For a linescan array to take high fidelity images, and for post-image processing and quantification, it is necessary to know have the sensing mechanism to be at a known position—both distance and angle, from the reflection point on the surface. It is also necessary for the linescan array to be angled correctly with respect to the surface being imaged. It is desired that a right angle normal to the surface be present between the linescan array and the light source. In some embodiments herein, a distance sensor first passes over the worksurface, to obtain accurate distance and curvature information, followed by the linescan array in a second pass. In the second pass, the linescan array may be moved in order to achieve the desired position of a right angle normal to the surface at each point inspected. In other embodiments, the distance sensor is placed ahead of the linescan array. Based on feedback from the distance sensor, the linescan array position with respect to the worksurface is adjusted in-situ.

FIG. 4A illustrates a schematic view of an imaging system 400 imaging a surface 402. A linescan array 410, behind a lens 420, faces a surface 402, with the right angle between array 410 and light source 440 being orthogonal to surface 402 at point 404 as array 410 captures images of surface 402.

Imaging system 400 also includes a distance sensor, or distance sensor array. As many vehicles have surfaces with curvature in more than one direction, it is important to have distance information for at least the distance that the length of array 410 will pass through. As described above, in some embodiments a distance sensor travels separately from system 400, for example as illustrated by sensor position 430b. In some embodiments, sensor position 430b is representative of a real-time position of a sensor with respect to system 400 such that a sensor array moves, as indicated by arrow 406, across surface 402 ahead of system 400. Sensor position 430b illustrates an embodiment where a sensor array moves independently from system 400. However, it is expressly contemplated that a sensor array may be mechanically coupled In some embodiments, however, sensor position 430b is indicative of movement of the sensor array during a first pass, prior to system 400 traversing along path 406.

In some embodiments, a sensor array is mechanically coupled to system 400, as indicated by sensor position 430a, such that the sensor array travels along path 406 in a fixed position with respect to system 400. The entire system 400, with a sensor array in position 430a, may move across surface 402 in a first pass, so that distance sensors may capture accurate topography for surface 402, and then in a second pass so that system 400 may capture images of surface 402.

As illustrated in the transition from FIG. 4A to 4B, an orientation of system 400 changes in order to maintain a right angle at a normal to the point 404 being imaged. Based on information from a position sensor array, a robot arm, or other movement mechanism for system 400, rotates and moves system 400 to maintain a desired distance from, and orientation with respect to, surface 402. One sensor array is needed for a surface with zero Gaussian curvature, such as a cylindrical surface. However, multiple sensor arrays may be used in embodiments with non-zero Gaussian curvature surfaces, such as a spherical surface.

It is desired to sand only as much as possible to remove a defect, polish enough to achieve the needed surface finish, and manage device settings such as force applied, dwell time and movement speed to reduce haze and scratches. Systems and methods herein provide helpful feedback for improved robotic control.

FIG. 4C illustrates an imaging system in accordance with embodiments herein. Imaging system 470 is controlled by a controller 480, which can receive instructions from an operator, for example using the illustrated keyboard. However, in some embodiments, system 460 is automatically controlled by controller 480, for example based on information received from a distance/position sensor or another source. System 470 is one instance of an imaging system that may be able to image and quantify haze. System 470 is illustrated as an instance of an imaging system fixed in place that can image flat surfaces. However, as discussed herein, in some embodiments, imaging systems are designed to follow curvature of a surface.

A linescan array 470 images a surface 466 which, in some embodiments, moves with respect to system 460. However, it is expressly contemplated that, in some embodiments, a worksurface remains stationary and system 460 is mobile. Light sources 462 is directed toward surface 466, so that light is reflected toward linescan array 470.

An orientation component 464, illustrated as a curved rail, may be used to maintain a desired orientation between light sources 462 and linescan array 470, while changing an orientation of system 460 with respect to a worksurface 466. This may be helpful in embodiments where surface 466 has curvature, to maintain a desired orientation of normal to a right angle formed by one of lights 462 and linescan array 470. In the illustrated embodiment, orientation component 464 operates independently to change the angle of light sources 462 and imaging device 470 with respect to surface 466. This may be preferred as the optimum arrangement to reveal and characterize a defect may differ based on the optical properties of the surface as well as the light incident angle and camera position.

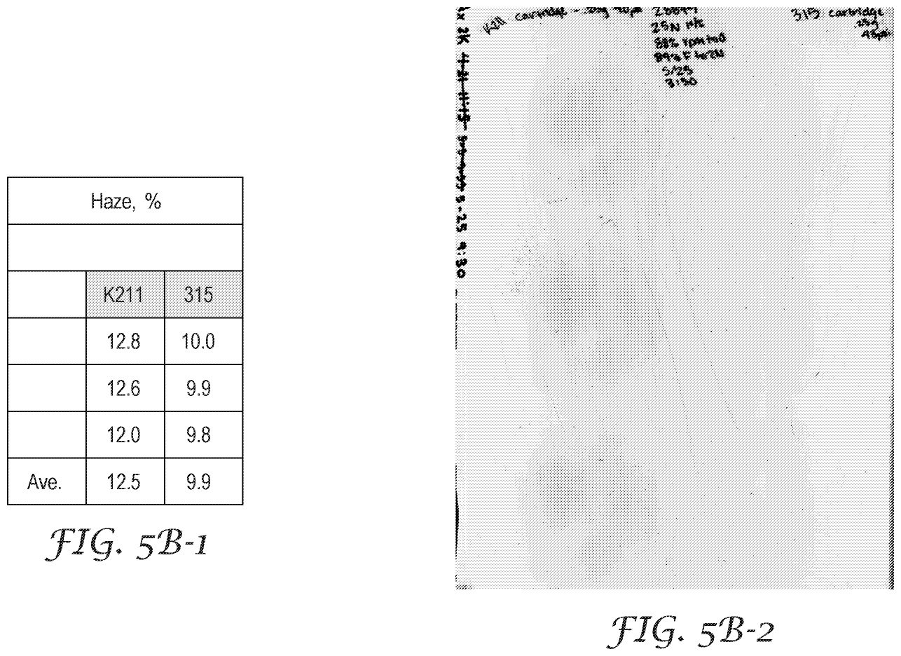

It was surprisingly found that the reduction in speed to the last point of the trajectory, spinning in a fixed position in the last spot, results in the visible, localized haze patterns illustrated in FIGS. 2B and 2D-2. FIGS. 5A-5B illustrate images, obtained using the system of FIGS. 4A-4C, under different process conditions and using different polishing compounds.

FIGS. 5A-5B illustrate process parameter for, and results of, abrading operations as described herein. 0.25 g of K211 polish (available from 3M Company), a 28874 polishing pad (available from 3M Company), a spiral trajectory with a 14 second total polishing time with a 25N applied downforce.

Most robotic buffing steps lower the buff pad to the surface, begin spinning the buff pad while moving the pad across the surface to be repaired in a designated path (the trajectory). This continues for a specified time and then the buff pad stops moving in the trajectory path, the article (e.g. buff pad) speed (rpm) is reduced to zero, and the tool is lifted off the surface. This creates an area of concentrated haze within the larger overall haze affected area, referred to here as a “bulls-eye” that is only readily apparent in certain light angles to the human eye. But depending on the severity of the haze, can be very noticeable. In addition to the overall severity of the haze, there is also a phenomenon known as the ‘hologram’, where the haze pattern is even more apparent as it appears to be holographic as a result of the micro scratches aligning with the trajectory pattern, causing the haze appears to move and grow more intense in certain areas as the eye and light angles change. This can be the most problematic portion of the haze as it is very noticeable in very bright light, like sunlight, appearing to ‘move’ or ‘dance’ across the surface as the relative angle of the viewer to the surface is slightly changed.

We have found that by implementing certain custom robot buffing trajectories we can greatly reduce both the bulls-eye and pinwheel effects. By tapering the buff pad rpm to zero before stopping the trajectory, the pinwheel effect was greatly reduced. In a separate method, lifting the buff pad off the surface before stopping the trajectory was shown to greatly reduce the bulls-eye.

FIG. 5A-1 illustrates resulting haze from process conditions used on the reflective surface of FIG. 5A-2, which was then imaged using the system of FIG. 4C to make the haze clearly visible. The reduction in speed, surprisingly, reduced the pinwheel effect seen.

It was initially expected, as explained in greater detail in Example 1, that changing the speed and/or force of contact would increase the probability of micro-surface scratches, e.g. making haze worse. Slowing the speed of a mineral-carrying product against a surface was expected to change the surface finish in a negative fashion because similar results were known in handheld tools, as illustrated, and explained in greater detail in Example 1.

In FIG. 5A-1, some improvement in haze was seen with a reduction of rotational speed to zero. However, it is noted that the hologram effect was dramatically reduced.

As seen in FIG. 5B-2, it was shown that reducing the significantly reducing the force before the abrasive article reaches the end of the trajectory saw improved surface finishes.

Reducing the applied force and/or relative position of the abrasive article against a surface (e.g. moving the robotic arm as the final position of the trajectory results in a measurable improvement in surface finish. Reduction in rotational speed approaching the end of the trajectory reduces haze and also reduces the hologram effect on the surface. While either of these changes saw improvements, the combination of both a reduction in speed and a reduction in applied force/relative position saw truly surprising results. As illustrated in FIG. 5B, haze is considerably reduced when the rotational speed was reduced to zero and the applied force reduced significantly. In the example illustrated in FIG. 5B-2, force was reduced enough to cause the abrasive article to lift off the surface. A similar effect could be achieved by changing the relative position as well.

The change in applied force can be achieved in one of two ways. In embodiments where a robotic abrading system has a force control unit, an applied force can be adjusted. In other embodiments, a relative position of the robotic arm with respect to a surface being abraded can be adjusted. Particularly for polishing operations, a polishing pad is compressed against the worksurface. Changing the relative position of the robot arm, by moving the robot arm away from the surface, results in a lower applied force. Either, or both, of these applied force adjustments may be used in embodiments herein.

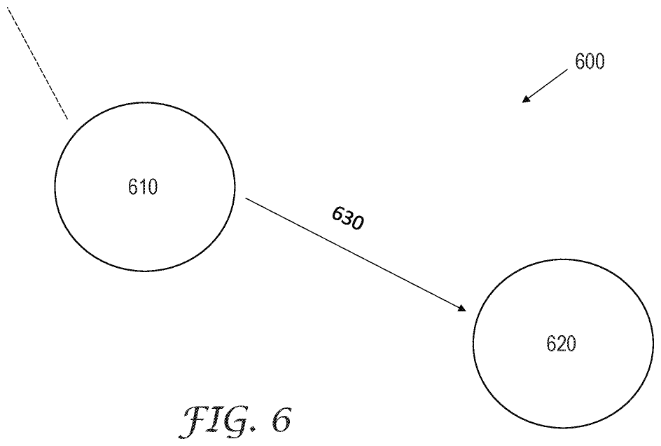

FIG. 6 illustrates a schematic for a surface processing operation in accordance with embodiments herein. A final point 620 on a trajectory is illustrated in schematic 600. It is desired to ensure that enough time is spent buffing/polishing the surface to remove sanding scratches while also decelerating and/or lifting off in time to reduce haze left on the surface.

Different overall repair trajectories are suitable for different defects, as discussed in e.g. as in U.S. Provisional patent application Ser. No. 17/756,444 Filed Nov. 24, 2020, for example, as well as PCT Publication WO 2022/038491, published on Feb. 24, 2022. Once a trajectory is selected, based on a defect type, shape and size, it needs to be modified to account for the initial defect-removal step (e.g. sanding step) and to include a tailored deceleration. For example, a post-sanding image of a defect area may be captured and, based on the success of a sanding operation, a polishing trajectory may be modified to increase or decreases total abrading time, or abrading aggressiveness (e.g. rotational speed and applied force) to achieve a desired surface appearance.

A portion of the trajectory may also be modified specifically to address haze. As illustrated in FIG. 6 a next-to-last point 610 is calculated based on a time needed to rapidly decelerate a rotational (or vibrational, orbital or random orbital) speed of the abrasive article, e.g. a speed that the abrasive article moves relative to the robot arm. The speed may be reduced significantly, for example more than 50%, more than 60%, more than 70%, more than 80%, more than 90%, or even completely to zero.

Additionally, or alternatively, the trajectory is modified to reduce an applied force, either by changing a z-axis position of the abrasive article with respect to the surface being abraded and/or changing an applied force.

Distance 630 represents the time and/or distance required to make the surface appearance trajectory modification. The surface appearance trajectory modification may be a rapid deceleration, a liftoff/force reduction, or a combination of both.

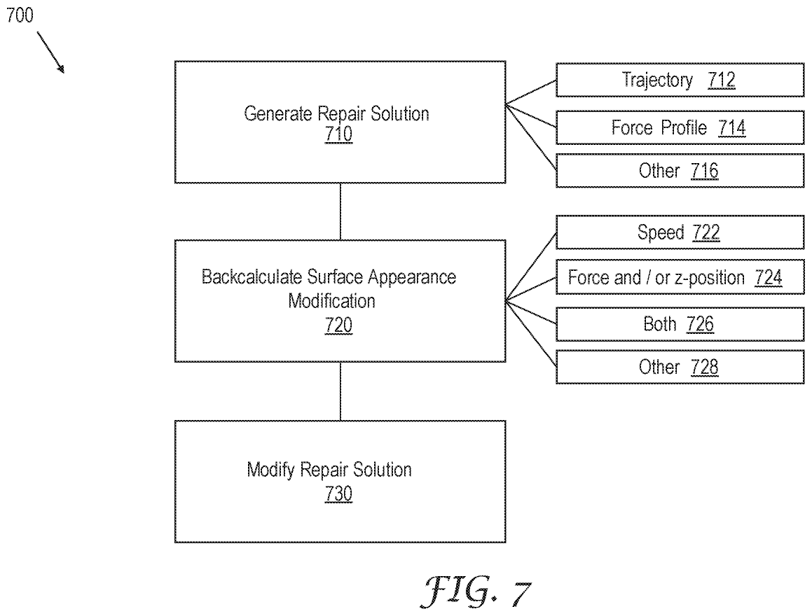

FIG. 7 illustrates a method of modifying a polishing repair solution in accordance with embodiments herein. Method 700 may be accomplished in situ by a robot controller based on an amount of material removed by a previous abrading step, based on a preferred surface appearance, and/or other specifications. For example, defects in different positions on an automobile may have different priorities based on visibility, or vehicle color. A black vehicle may have a lower haze tolerance than a white vehicle, for example, while a defect on a vehicle hood may have a lower haze tolerance than one on the roof of a vehicle.

At block 710, a polishing repair solution is generated. The repair solution may be generated by selecting a trajectory 712 and force profile 714 based on polishing needed, e.g. based on an amount of material removed during a sanding operation. The repair solution may be generated based on a defect location, defect type, or other parameter. Other considerations 716 may also influence a repair solution.

At block 720, the repair solution is modified based on surface appearance needs. The surface appearance modification may include a speed reduction 722, in some embodiments. In some embodiments, the surface appearance modification may include a reduction in applied force and/or z-position 724 of the abrasive article with respect to the surface. In some embodiments, both 726 a speed and a force/z-position are modified. Other parameter modifications 728 may also be included.

At block 730, the repair solution is modified. The goal of method 700 is to maintain short cycle times while achieving desired surface appearance. So, while haze may be reduced further by lengthening the entire trajectory, or by adding additional trajectory steps, it is desired to achieve the needed surface appearance with the least disruption to cycle time. In some embodiments, the cycle time increase is less than 20%, or even less than 10%.

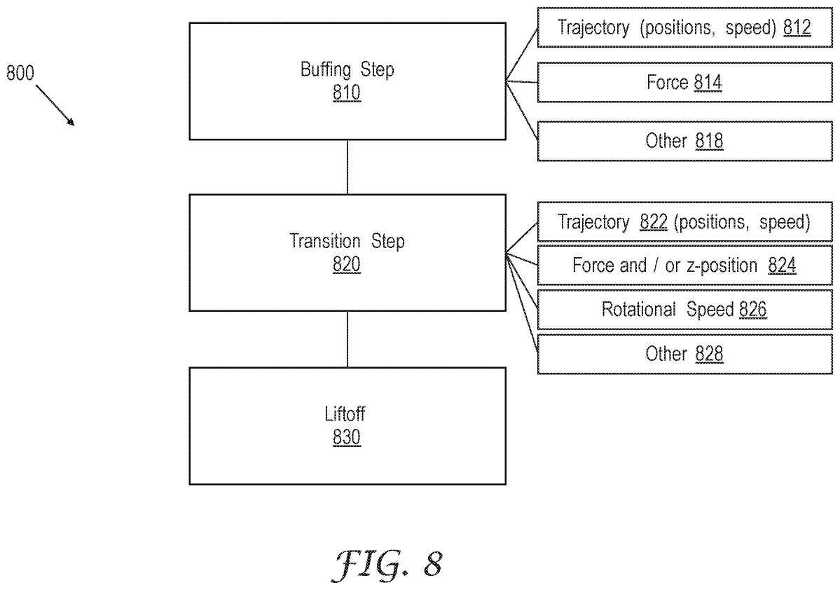

FIG. 8 illustrates a method of abrading a surface in accordance with embodiments herein. Method 800 may be used after an initial sanding step, after a polishing step, or after another abrading step, to provide a desired surface appearance of a worksurface.

At buffing or polishing step 810 occurs. The buffing step is completed by an abrasive article coupled to a robotic arm. The robotic arm moves the abrasive article according to a trajectory 812, and applies a suitable force profile 814 along trajectory 812. The trajectory may have other parameters 818 of interest, such as angle, speed of rotation/orbit, random orbit or vibration, etc.

A transition 820 occurs between buffing step 810 and an end 830 of the abrading operation. The operation may end 830 in a liftoff from the surface, as illustrated in FIG. 8. However, it is expressly contemplated that the abrasive article does not need to completely separate from a worksurface for an operation to be considered complete.

During the transition step 820, the robot arm continues to follow a trajectory 822, which may be the same as, or a modified version of trajectory of trajectory 812. For example, a speed across a worksurface may increase or decrease as the trajectory approaches an end point. An applied force on the abrasive article and/or z-axis position 824 of the abrasive article with respect to the surface may change. The applied force may decrease, either by adjusting a force control unit or changing a z-axis position of the abrasive article with respect to the worksurface, by 30%, or by 40%, or by 50%, or by 60%, or by 70%, or by 80% or by 90% or the abrasive article may completely detach from the worksurface. A rotational speed 826 of the abrasive article (or orbital or random orbital speed) may decrease as well, for example by 50%, by 60%, by 70%, by 80%, by 90% or even by 100%. Other parameter values 828 may also be adjusted to achieve the desired surface appearance.

It is noted that hand-held power tools, in the hands of trained operators, can achieve force and speed reductions. However, human operators cannot achieve consistent, repeatable reductions in applied force and/or speed while maintaining efficient cycle times.

Transition step 820, in some embodiments, is accomplished in less than 3 seconds, less than 2 seconds or even less than 1 second.

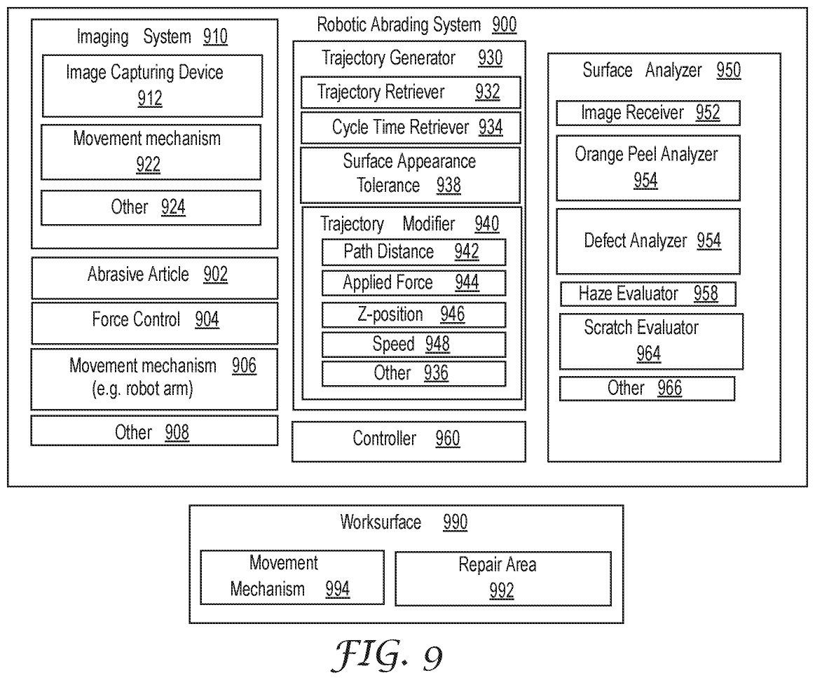

FIG. 9 illustrates a robotic abrading system in accordance with embodiments herein. Robotic abrading system 900 includes, or is communicably coupled to, an imaging system 910 that captures images of a surface, using image capturing device 912, that are used by a surface analyzer 950 to select a trajectory and generate a repair solution for a detected defect. Imaging system 910 may have a movement mechanism 922 that brings it near enough to image a surface, as well as other functionality 924.

Image receiver 952 may receive images from image capturing device 912. The received images may be analyzed by an orange peel analyzer 954, that determines a level of orange peel surrounding a repair site before an abrading operation so that the repair can integrate the repaired surface with the surrounding unabraded area and determine whether the integration was successful after the operation. A defect analyzer 954 may determine a type, size and severity of a defect to be repaired on the surface before an abrading operation and, after the abrading operation, determine whether the defect was sufficiently removed. A haze evaluator 958 may be used after an abrading operation to determine whether the remaining haze is acceptable. A scratch evaluator 964 may be used to evaluate scratches between steps in an abrasive operation, or after an abrasive operation is complete. Surface analyzer 950 may have other functionality 966.

Based on surface conditions of a worksurface 990, a trajectory generator 930 generates a modified trajectory based on a selected default repair trajectory (selected, for example, based on results of a previous abrading operation or based on an initial analysis of surface 990 pre-repair) to achieve desired surface appearance conditions.

Trajectory retriever 932 retrieves an initial trajectory, for example from a database (not shown) of trajectories, or from controller 960 that generated the initial trajectory. Cycle time retriever 934 retrieves a cycle time of the retrieved trajectory, and cycle time limits for the defect repair. For example, some defects are expected to take longer to repair, and it may be preferable to add cycle time for a given defect instead of deferring until after a defect repair to address haze. Some defects are deemed to be too large or too complex to repair based on a defect analysis. It may, similarly, be determined that addressing surface appearance concerns would take longer than cycle time constraints would allow and, therefore, a surface appearance repair step, or the entire defect repair, may be deferred. Trajectory generator may also retrieve a surface appearance tolerance 938. For example, more haze may be acceptable depending on a surface color or a location of a repair area. For example, the roof of a truck may have a higher haze tolerance since it is infrequently seen, while a hood of the same truck may have a lower haze tolerance because if its visibility.

Trajectory modifier 940 determines a path distance 942 necessary to achieve a desired speed reduction and/or force reduction correlating to an acceptable haze appearance on worksurface 990. Path distance 942 is selected to allow sufficient distance (and, therefore, trajectory time) for a surface appearance modification to be implemented while maintaining an efficient cycle time for the given defect.

A surface appearance modification may include a change in applied force 944, for example applied by a force control unit 904. A surface appearance modification may include a change in a z-axis position 946 of abrasive article 902 against worksurface 990. Abrasive article 902 may be a compressible article such that changing a z-axis position of a contact point between an end-of-arm of movement mechanism 906 keeps a portion of abrasive article 902 in contact with worksurface 990. The surface appearance modification may include reducing a speed 948 of the abrasive article 902. For example, while abrasive article 902 is moving toward an end of a trajectory, a rotational, orbital, random orbital or vibrational speed is reduced such that the abrasive article 902 is moving slower, or is stationary, when the repair trajectory is finished. Other parameters 936, such as attack angle, translational speed across worksurface 990, or other suitable parameters may also be adjusted by trajectory modifier 940.

Worksurface 990 may have its own movement mechanism 994, in some embodiments. A trajectory may include movement both of movement mechanism 906 and/or movement mechanism 994. Worksurface 990 may be a vehicle, for example. Worksurface 990 may have curvature in one or more directions, such that movement mechanisms 906 and/or 994 cause abrasive article 902 to follow curvature of worksurface 990.

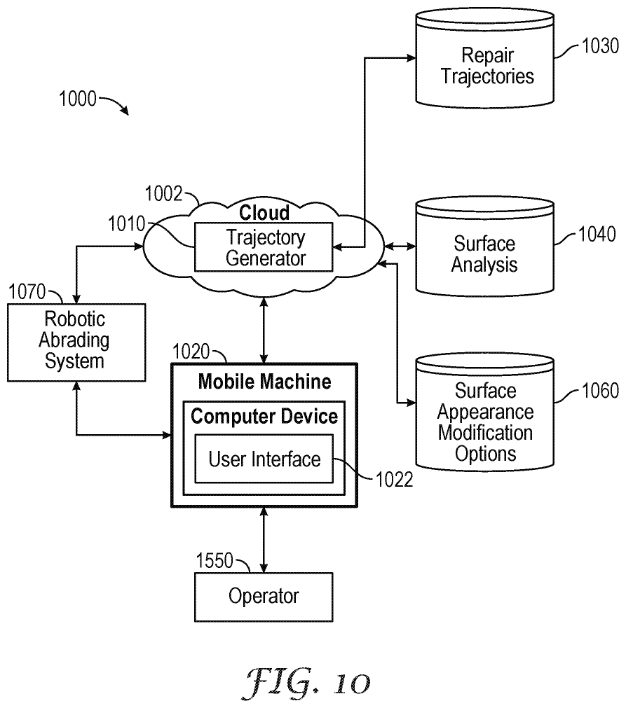

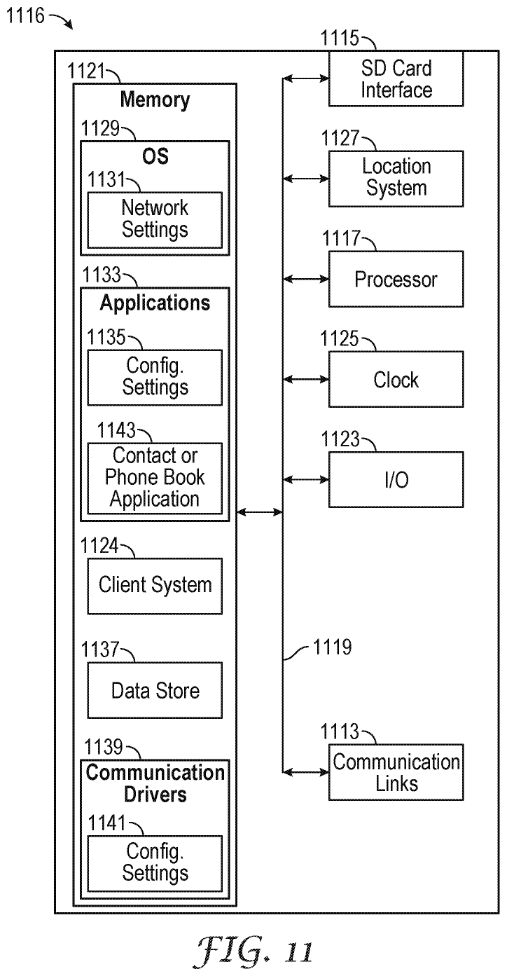

FIG. 10 is a robotic abrading system architecture. The surface processing system architecture 1000 illustrates one embodiment of a robotic abrading system 1070 that interacts with a trajectory generator 1010 that generates a trajectory suited for abrading a surface to a desired surface appearance. However, while trajectory generator 1010 is illustrated as separate from robotic abrading system 1070, it is expressly contemplated that a controller of robotic abrading system 1070 may be incorporated into robotic abrading system 1070.

As an example, surface process system 1000 can provide computation, software, data access, and storage services that do not require end-user knowledge of the physical location or configuration of the system that delivers the services. In various embodiments, remote servers can deliver the services over a wide area network, such as the internet, using appropriate protocols. For instance, remote servers can deliver applications over a wide area network and they can be accessed through a web browser or any other computing component.

Software or components shown or described in FIGS. 1-9 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided by a conventional server, installed on client devices directly, or in other ways.

FIG. 10 specifically shows that a trajectory generator 1010 can be located at a remote server location 1002. Therefore, computing device 1020 accesses those systems through remote server location 1002. Operator 1050 can use computing device 1020 to access user interfaces 1022 as well.

FIG. 10 shows that it is also contemplated that some elements of systems described herein are disposed at remote server location 1002 while others are not. By way of example, storage 1030, 1040 or 1060 or robotic systems 1070 can be disposed at a location separate from location 1002 and accessed through the remote server at location 1002. Regardless of where they are located, they can be accessed directly by computing device 1020, through a network (either a wide area network or a local area network), hosted at a remote site by a service, provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers.

It will also be noted that the elements of systems described herein, or portions of them, can be disposed on a wide variety of different devices. Some of those devices include servers, desktop computers, laptop computers, imbedded computer, industrial controllers, tablet computers, or other mobile devices, such as palm top computers, cell phones, smart phones, multimedia players, personal digital assistants, etc.

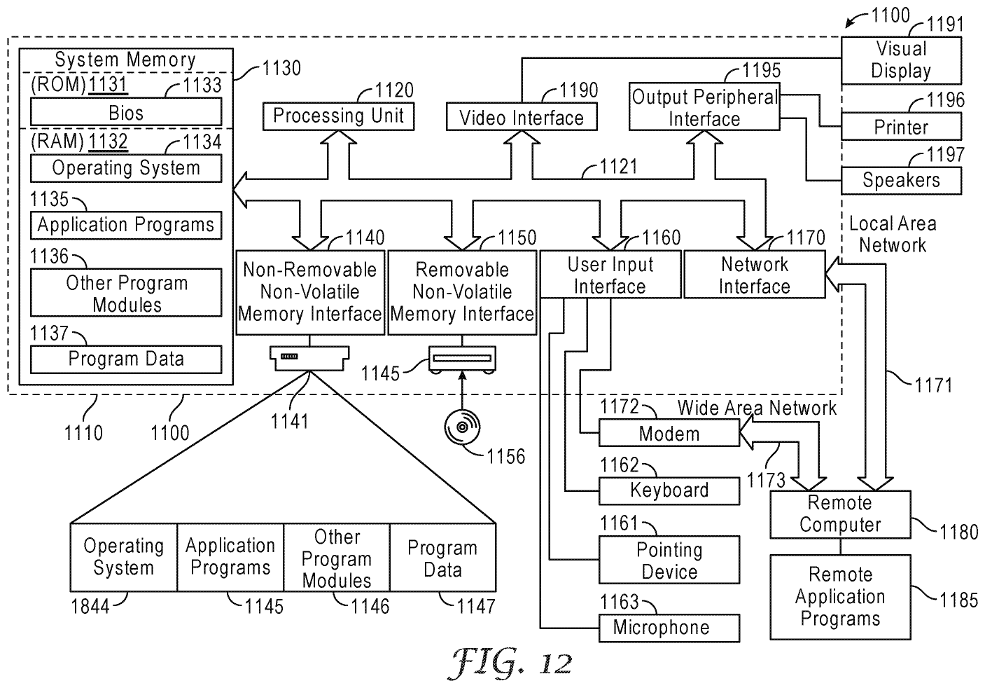

FIGS. 11-12 show examples of computing devices that can be used in embodiments shown in previous Figures.

FIG. 11 is a simplified block diagram of one illustrative example of a handheld or mobile computing device that can be used as a user's or client's handheld device 1116 (e.g., as computing device 1020 in FIG. 10), in which the present system (or parts of it) can be deployed. For instance, a mobile device can be deployed in the operator compartment of computing device 920 for use in generating, processing, or displaying the data.

FIG. 11 provides a general block diagram of the components of a client device 1116 that can run some components shown and described herein. Client device 1116 interacts with them, or runs some and interacts with some. In the device 1116, a communications link 1113 is provided that allows the handheld device to communicate with other computing devices and under some embodiments provides a channel for receiving information automatically, such as by scanning. Examples of communications link 1113 include allowing communication though one or more communication protocols, such as wireless services used to provide cellular access to a network, as well as protocols that provide local wireless connections to networks.

In other examples, applications can be received on a removable Secure Digital (SD) card that is connected to an interface 1115. Interface 1115 and communication links 1113 communicate with a processor 1117 (which can also embody a processor) along a bus 1119 that is also connected to memory 1121 and input/output (I/O) components 1023, as well as clock 1125 and location system 1127.

I/O components 1123, in one embodiment, are provided to facilitate input and output operations and the device 1116 can include input components such as buttons, touch sensors, optical sensors, microphones, touch screens, proximity sensors, accelerometers, orientation sensors and output components such as a display device, a speaker, and or a printer port. Other I/O components 1123 can be used as well.

Clock 1125 illustratively comprises a real time clock component that outputs a time and date. It can also provide timing functions for processor 1117.

Illustratively, location system 1127 includes a component that outputs a current geographical location of device 1116. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 1121 stores operating system 1129, network settings 1131, applications 1133, application configuration settings 1135, data store 1137, communication drivers 1139, and communication configuration settings 1141. Memory 1121 can include all types of tangible volatile and non-volatile computer-readable memory devices. It can also include computer storage media (described below). Memory 1121 stores computer readable instructions that, when executed by processor 1117, cause the processor to perform computer-implemented steps or functions according to the instructions. Processor 1117 can be activated by other components to facilitate their functionality as well.

FIG. 12 is a block diagram of a computing environment that can be used in embodiments shown in previous Figures.

FIG. 12 is one example of a computing environment in which elements of systems and methods described herein, or parts of them (for example), can be deployed. With reference to FIG. 12, an example system for implementing some embodiments includes a general-purpose computing device in the form of a computer 1210. Components of computer 1210 may include, but are not limited to, a processing unit 1220 (which can comprise a processor), a system memory 1230, and a system bus 1221 that couples various system components including the system memory to the processing unit 1220. The system bus 1221 may be any of several types of bus structures including a memory bus or memory controller, a peripheral bus, and a local bus using any of a variety of bus architectures. Memory and programs described with respect to systems and methods described herein can be deployed in corresponding portions of FIG. 12.

Computer 1210 typically includes a variety of computer readable media. Computer readable media can be any available media that can be accessed by computer 1210 and includes both volatile/nonvolatile media and removable/non-removable media. By way of example, and not limitation, computer readable media may comprise computer storage media and communication media. Computer storage media is different from, and does not include, a modulated data signal or carrier wave. It includes hardware storage media including both volatile/nonvolatile and removable/non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1230 includes computer storage media in the form of volatile and/or nonvolatile memory such as read only memory (ROM) 1231 and random access memory (RAM) 1232. A basic input/output system 1233 (BIOS) containing the basic routines that help to transfer information between elements within computer 1210, such as during start-up, is typically stored in ROM 1231. RAM 1232 typically contains data and/or program modules that are immediately accessible to and/or presently being operated on by processing unit 1220. By way of example, and not limitation, FIG. 12 illustrates operating system 1234, application programs 1235, other program modules 1236, and program data 1237.

The computer 1210 may also include other removable/non-removable and volatile/nonvolatile computer storage media. By way of example only, FIG. 12 illustrates a hard disk drive 1241 that reads from or writes to non-removable, nonvolatile magnetic media, nonvolatile magnetic disk 1252, an optical disk drive 1255, and nonvolatile optical disk 1256. The hard disk drive 1241 is typically connected to the system bus 1221 through a non-removable memory interface such as interface 1240, and optical disk drive 1255 are typically connected to the system bus 1221 by a removable memory interface, such as interface 1250.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for the computer 1210. In FIG. 12, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237.

A user may enter commands and information into the computer 1210 through input devices such as a keyboard 1262, a microphone 1263, and a pointing device 1261, such as a mouse, trackball or touch pad. Other input devices (not shown) may include a joystick, game pad, satellite receiver, scanner, or the like. These and other input devices are often connected to the processing unit 1220 through a user input interface 1260 that is coupled to the system bus, but may be connected by other interface and bus structures. A visual display 1291 or other type of display device is also connected to the system bus 1221 via an interface, such as a video interface 1290. In addition to the monitor, computers may also include other peripheral output devices such as speakers 1297 and printer 1296, which may be connected through an output peripheral interface 1295.

The computer 1210 is operated in a networked environment using logical connections, such as a Local Area Network (LAN) or Wide Area Network (WAN) to one or more remote computers, such as a remote computer 1280.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. In a networked environment, program modules may be stored in a remote memory storage device. FIG. 12 illustrates, for example, that remote application programs 1285 can reside on remote computer 1280.

A method of repairing a defect on a surface is presented that includes imaging the surface to locate the defect with an imaging system. The method also includes selecting a first abrasive trajectory, for a first abrasive operation, based on an indication from the imaging system. The method also includes conducting the first abrasive operation by contacting the surface with a first abrasive article. The first abrasive article is pressed into contact with the surface in an area of the defect by a robotic repair system. The method also includes selecting a second trajectory for a second abrasive operation. The second abrasive operation includes contacting the surface with a second abrasive article in an area of the abraded surface. The second trajectory includes one of: a reduction in rotational, orbital or random orbital speed of the abrasive article by at least 90% before the trajectory endpoint is reached, a reduction in applied force by at least 90% before the trajectory endpoint is reached, or a separation of the abrasive article and the surface before the trajectory endpoint is reached. The method also includes actuating the robotic repair unit to execute the second trajectory.

The method may be implemented such that selecting the second trajectory includes: retrieving a default abrasive trajectory and generating a surface appearance modification for the default abrasive trajectory. The generated surface appearance is generated based on a surface indication captured by a second imaging system. The method also includes calculating a path length required to execute the surface appearance modification such that the surface modification is executed before the trajectory reaches an endpoint. The method also includes generating the second trajectory by modifying the abrasive trajectory to include the surface appearance modification.

The method may be implemented such that the surface appearance modification is selected from the group consisting of: a rotational speed reduction of the second abrasive article when in contact with the surface, an orbital speed reduction of the second abrasive article when in contact with the surface, a random orbital speed reduction of the second abrasive article when in contact with the surface, a vibrational rate of the second abrasive article when in contact with the surface, an applied force on the second abrasive article when in contact with the surface, and a z-axis position of an end-of arm of the robotic repair system with respect to the surface.

The method may be implemented such that, before the endpoint, the rotational speed is reduced to zero, the orbital speed is reduced to zero, the random orbital speed is reduced to zero or the vibrational rate is reduced to zero.

The method may be implemented such that the applied force and/or the z-axis position is reduced such that the abrasive article decouples from the surface prior to the endpoint.

The method may be implemented such that the second imaging system is the first imaging system.

The method may be implemented such that the first imaging system is positioned on a robotic arm of the robotic repair system.

The method may be implemented such that the first abrasive article is a sanding disc and the second abrasive article is a polishing pad.

A method of modifying a surface appearance of a reflective surface is presented that includes contacting an abrasive article to the reflective surface and moving the abrasive article along the reflective surface. Moving includes a robotic arm moving the abrasive article traveling at a translational speed, with an applied force, from a starting point to an ending point. Before reaching the ending point, a movement speed relative to the robotic arm is reduced by more than 50%.

The method may be implemented such that the movement speed is a rotational speed, an orbital speed, a random orbital speed or a vibrational speed.

The method may be implemented such that the movement speed is reduced by more than 90%.

The method may be implemented such that the movement speed is reduced by more than 95%.

The method may be implemented such that the movement speed is reduced by more than 99%.

The method may be implemented such that, before reaching the end point, an effective force by the robot arm on the abrasive article is reduced by more than 50%.

The method may be implemented such that the effective force is an applied force generated by a force control unit.

The method may be implemented such that the effective force is generated by a change in position of the robot arm with respect to the reflective surface.

The method may be implemented such that the effective force is reduced by more than 90%.

The method may be implemented such that the effective force value is reduced to a negative value.

A method of modifying a surface appearance of a reflective surface is presented that includes contacting an abrasive article to the reflective surface. The method also includes moving the abrasive article along the reflective surface. Moving includes a robotic arm moving the abrasive article traveling at a translational speed, with an applied force, from a starting point to an ending point. Before reaching the ending point, an effective force on the abrasive article, by the robotic arm, is reduced by more than 50%.

The method may be implemented such that the effective force is an applied force generated by a force control unit.

The method may be implemented such that the effective force is generated by a change in position of the robot arm with respect to the reflective surface.

The method may be implemented such that the effective force is reduced by more than 90%.

The method may be implemented such that the effective force value is reduced to a negative value.

The method may be implemented such that the effective force is reduced below 5 Newtons.

The method may be implemented such that, before reaching the end point, a relative speed of the abrasive article with respect to the robot arm is reduced by more than 50%.

The method may be implemented such that the movement speed is a rotational speed, an orbital speed, a random orbital speed or a vibrational speed.

The method may be implemented such that the movement speed is reduced by more than 90%.

The method may be implemented such that the movement speed is reduced by more than 95%.

The method may be implemented such that the movement speed is reduced by more than 99%.

A surface abrading system is presented that includes a robot arm with an end effector on an end of the robot arm. The end effector is configured to couple to an abrasive article. The system also includes a movement mechanism that moves the robot arm with respect to a surface. The system also includes a robot controller that causes the robot arm to execute an abrasive trajectory on the surface. The abrasive trajectory includes the abrasive article in contact with the surface. The robot controller includes: a trajectory retriever that retrieves an abrasive trajectory. The abrasive trajectory includes a surface appearance portion prior to an endpoint, and the surface appearance portion includes a reduction in relative movement speed between the robot arm and the abrasive article or a reduction in effective applied force on the abrasive article. The robot controller also includes a command generator that communicates the abrasive trajectory to the movement mechanism to execute the trajectory.

The system may be implemented such that the surface appearance trajectory is generated by a trajectory generator that includes: a default trajectory retriever that retrieves a default trajectory and a surface appearance tolerance retriever that retrieves a surface appearance tolerance, the surface appearance tolerance including an acceptable haze threshold. The trajectory generator also includes a trajectory modifier that applies a trajectory modification to the default trajectory based on the surface appearance tolerance. The modified default trajectory is the abrasive trajectory.

The system may be implemented such that the abrasive article is a compressible abrasive article.

The system may be implemented such that the trajectory modification is a change in z-axis position of the end of the robot arm with respect to the surface.

The system may be implemented such that the system further includes a force control unit. The trajectory modification is a reduction in applied force.

The system may be implemented such that the end effector is configured to rotate the abrasive article while the abrasive article is in contact with the surface. The trajectory modification is a reduction in rotational speed of the abrasive article while in contact with the surface.

The system may be implemented such that the end effector is configured to move the abrasive article in an orbital motion while the abrasive article is in contact with the surface. The trajectory modification is a reduction in orbital speed of the abrasive article while in contact with the surface.

The system may be implemented such that the end effector is configured to move the abrasive article in a random orbital motion while the abrasive article is in contact with the surface. The trajectory modification is a reduction in random orbital speed of the abrasive article while in contact with the surface.

The system may be implemented such that the end effector is configured to cause the abrasive article to vibration while the abrasive article is in contact with the surface. The trajectory modification is a reduction in vibrational frequency of the abrasive article while in contact with the surface.

The system may be implemented such that the end effector is configured to move the abrasive article translationally across the surface. The trajectory modification is a reduction in translational speed.

The system may be implemented such that the controller further includes a cycle time retriever that retrieves a default cycle time for the default trajectory. The modified trajectory is within a cycle time tolerance of the default trajectory.

The system may be implemented such that the cycle time tolerance includes a modified cycle time being between 100%-200% of the default cycle time.

The system may be implemented such that the default trajectory is retrieved based on a defect identified on the surface.

The system may be implemented such that the default trajectory is retrieved based on a surface analysis of the surface.

The system may be implemented such that the abrasive trajectory is a second abrasive trajectory. The system further includes: a surface imaging system that images the surface after a first abrasive operation, with a first abrasive trajectory, has finished, and a surface analyzer that generates a surface indication based on the surface imaging. The trajectory modification is based on the surface indication.

The system may be implemented such that the surface indication includes a surface haze indication.

The system may be implemented such that the surface indication includes a surface scratch severity indication.

The system may be implemented such that it includes a display configured to display the trajectory.

The system may be implemented such that the surface includes curvature. The trajectory includes adjusting a relative position of the end of the robot arm with respect to the surface such that the abrasive article following the curvature.

A method of generating a trajectory for an abrasive operation is presented that includes selecting a default trajectory from a trajectory datastore, with a trajectory retriever. The default trajectory includes a time-parametrized path of travel for an abrasive article on a surface to be abraded. The method also includes retrieving a surface appearance tolerance for the surface. The method also includes calculating a surface appearance modification for the default trajectory based on the surface appearance tolerance. The method also includes generating the trajectory by modifying the time-parametrized path to accommodate the surface appearance modification. The surface appearance modification includes altering a parameter of the default trajectory along the time-parametrized path. The method also includes generating a command that, when received by a robotic abrading unit, causes the robotic abrading unit to execute the trajectory.

The method may be implemented such that generating the trajectory further includes: calculating a time period needed to achieve the surface appearance modification and modifying the trajectory so that surface appearance modification is completed in the time period.

The method may be implemented such that the time period, and a modified time-parametrized path of travel, replaces a portion of the trajectory.

The method may be implemented such that the replaced portion is at an end of the trajectory.

The method may be implemented such that the time period, and a modified time-parametrized path of travel, is added to the trajectory.

The method may be implemented such that the default trajectory is based on a surface analysis after a previous abrasive operation.

The method may be implemented such that the default trajectory is based on an identified surface defect on the surface.

The method may be implemented such that selecting a default trajectory further includes selecting a default force profile for the default trajectory, and generating the command includes generating a force control command for a force control unit of the robotic abrading unit to execute in conjunction with the trajectory.

The method may be implemented such that the surface modification includes a modified force profile.

The method may be implemented such that the modified force profile reduces an applied force by 90% before an end of a trajectory.

The method may be implemented such that the force profile goes to a negative value by the end of the trajectory.

The method may be implemented such that the default force profile has a maximum applied force. The modified force profile reduces an applied force to less than 10% of a maximum applied force at a trajectory end.

The method may be implemented such that the applied force is a negative value before the trajectory end.

The method may be implemented such that the surface modification includes a reduction in translational speed of travel of the abrasive article along the surface.

The method may be implemented such that the robotic repair unit includes an end effector that couples to the abrasive article. The end effector is configured to move the abrasive article, with respect to the robotic repair unit, during the abrasive operation. The surface appearance modification is a reduction in relative motion speed.

The method may be implemented such that the reduction is a gradual decrease in speed over a time period. The time period ends at the trajectory end.

The method may be implemented such that the time period is a fraction of a trajectory time period.

The method may be implemented such that the end effector rotates the abrasive article.

The method may be implemented such that the end effector moves the abrasive article in an orbital pattern.

The method may be implemented such that the end effector moves the abrasive article in a random orbital pattern.

The method may be implemented such that the end effector vibrates the abrasive article.

The method may be implemented such that a translational speed of the abrasive article on the surface is unchanged from the default trajectory to the trajectory during the time period.

A method of conducting an abrasive operation is presented that includes retrieving, using a trajectory retriever, an initial trajectory for the abrasive operation on a surface. The initial trajectory is part of a set of trajectories generated for the surface. The initial trajectory includes a time-parametrized path along the surface for an abrasive article. The method also includes generating a surface appearance modification for the initial trajectory based on a surface appearance parameter. The method also includes modifying the initial trajectory, using a trajectory modifier, to include the surface appearance modification. The initial trajectory has a first portion and a second portion that follows the first portion. The surface appearance modification modifies the second portion. The method also includes executing the modified trajectory, using a robotic repair unit. The robotic repair unit causes the abrasive article to the modified trajectory along the surface.

The method may be implemented such that the surface appearance modification is a reduction in applied force applied by a force control unit of the robotic repair unit.

The method may be implemented such that the surface appearance modification is a reduction in speed of the abrasive article relative to the robotic repair unit.

The method may be implemented such that a translational speed of the abrasive article relative to the worksurface is unchanged.

The method may be implemented such that a relative motion of the abrasive article with respect to the robotic repair unit is rotational, orbital, random orbital or linear.

The method may be implemented such that the surface appearance modification is a change in a relative position of an end-of-arm of the robotic repair unit with respect to the surface.

The method may be implemented such that the surface appearance parameter is generated based on a surface analysis of the surface after a previous abrasive operation.

The method may be implemented such that the surface appearance parameter is generated based on a detected defect on the surface.

The method may be implemented such that the surface appearance parameter is an allowable haze threshold.

The method may be implemented such that the first portion of the trajectory remains unchanged.

The method may be implemented such that the second portion is modified such that an abrading parameter is changed in a stepwise manner.

The method may be implemented such that the second portion is modified such that an abrading parameter is changed gradually.

The method may be implemented such that the surface includes curvature. The initial trajectory is retrieved based on the curvature.

### EXAMPLES

### Example 1: Pneumatic Sanding Systems

Pneumatic Random Orbital Sanders (ROS) are simple air-driven tools used for many applications, however, the primary use is to remove stock are provide an acceptable surface finish no matter what the application. The application could be a simple one-step process or a complex progressive sanding application where the first step is completed using an aggressively graded abrasive followed by subsequent steps of finer abrasives until the desired finish is achieved.

The functionality of pneumatic ROS is predicated upon them being supplied with the appropriate pressure and volume of clean, dry compressed air as well as periodic preventative maintenance such as oiling. In order to achieve the proper rpm 3M ROS are required to be supplied with 90 psi of compressed air through a ⅜″ ID airline. It is critical that the air pressure be measured at the tool while the throttle is being actuated and the sanding system is not in contact with the substrate that is being abraded. Note: in order to limit the possibility of adverse pressure drop air line length should be less than 25 feet.

The pressure and volume of compressed air have a direct impact on the rpm a pneumatic sander can generate. Therefore, one can deduce that when the proper rpm is not achieved there is an impact on the surface finish that is generated. Surface finish is defined as the measure of all the minute surface irregularities that exist after the substrate is abraded. There are many different surface finish parameters, however, two of the most relevant, especially as it relates to paint application, are Ra and Rz. Definitions for these parameters can be found at various sites on the Internet (see the attached as an example https://www.taylor-hobson.com/resource-center/blog/2020/october/what-is-surface-finish-and-types-of-surface-finish-parameters). Surface finish can be impacted by other factors such as the operator, type of disc pad selected, construction of the abrasive article, etc. However, when all factors, with the exception of air pressure are held constant, one can conduct tests which show the change in surface as it relates to air pressure.

Assuming 90 psi dynamic air pressure as the target, studies suggest that as the air pressure is lowered, which equates to less rpm, the surface finish typically tends to get coarser. The slowing of the abrasive system provides an opportunity for the abrasive article to have more interaction time with the substrate thus producing deeper, more aggressive scratch patterns. These more aggressive scratches, when coated, tend to present themselves as secondary defects from the abrasive process. Common terminologies for these secondary defects are as follows, “Wild Scratches, Sand Scratch Telegraphing, Off-Color Spots, etc.” As an example in one suggest study, a substrate was abraded with a P120 abrasive where the dynamic air pressure was set to 90 psi. After which surface finish measurements were conducted. Using the same abrasive system, however, dropping the air pressure to 70 psi and using a new P120 abrasive from the same lot of material, a separate area on the same substrate was abraded. Subsequent surface finish measurements were conducted. The comparison of the parameters measure resulted in the following: Ra=11.4% more aggressive finish at 70 psi, Rz=22.2% more aggressive finish at 70 psi, and Rmax=17.3% more aggressive finish at 70 psi. Note: the measured change in tool rpm was determined to be approximately 1000 rpms in this instance. Although the significance of the surface finish change was not determined, the importance of this exercise was to stress the impact that proper functionality of an pneumatically powered random orbital can introduce into customer operations.

### Example 2

### Control Spiral (Comparative Example)

An industrial robot arm was fitted at the end of arm with 3M active compliant tool (6530, 3M Company, St. Paul, MN) and a 3M servo random orbital buffer motor (77540, 3M Company, St. Paul, MN) The buffer motor was attached directly to the active compliant tool. A back up pad (20350, 3M Company, St. Paul, MN) was attached to the end of the servo motor. A polishing pad (28874, 3M Company, St. Paul, MN) was attached to the end of the back up pad. A painted panel (57080 black painted panel, ACT Test Panels LLC, Hillsdale, MI) was placed on a table approximately 125 mm from the polishing pad.

Approximately 0.3 g of polishing compound (K211 polishing compound, 3M Company, St. Paul, MN) was placed on the painted panel directly below the polishing pad. A planned pathway was sent from a computer to the robot. The polishing pad was pressed down onto the panel with 25N of downward force. The servo motor was spun up to 8500 rpm while simultaneously beginning a spiral movement in the X-Y plane of the painted panel. The spiral began at a radius of 5 mm and spiraled outward to a radius of 20 mm at a traverse speed of 0.05 m/s for a total spiral time of 14 seconds. After the traverse speed reached zero, then the servo motor rpm dropped to zero. The robot then lifted the polishing pad away from the surface of the painted panel.

The residual polishing compound on the painted panel surface was wiped away using a wiping cloth (3M Detailing Cloth 39016, 3M Company, St. Paul, MN). The resultant polished surface was analyzed using the system illustrated and described in U.S. Provisional Patent Application No. 63/363,056, filed on Apr. 15, 2022.

Using the equation below, the average haze value, H, over the whole repaired area can be estimated:

H=(1−(Li/255))×100

Where Li is the mean light intensity value of the repaired area. The haze values are shown in FIG. 5A-1, “control”.

### Example 2A: Reduction to 0 rpm

An industrial robot arm was fitted at the end of arm with 3M active compliant tool (6530, 3M Company, St. Paul, MN) and a 3M servo random orbital buffer motor (77540, 3M Company, St. Paul, MN) The buffer motor was attached directly to the active compliant tool. A back up pad (20350, 3M Company, St. Paul, MN) was attached to the end of the servo motor. A polishing pad (28874, 3M Company, St. Paul, MN) was attached to the end of the back up pad. A painted panel (57080 black painted panel, ACT Test Panels LLC, Hillsdale, MI) was placed on a table approximately 125 mm from the polishing pad.

Approximately 0.3 g of polishing compound (K211 polishing compound, 3M Company, St. Paul, MN) was placed on the painted panel directly below the polishing pad. A planned pathway was sent from a computer to the robot. The polishing pad was pressed down onto the panel with 25N of downward force. The servo motor was spun up to 8500 rpm while simultaneously beginning a spiral movement in the X-Y plane of the painted panel. The spiral began at a radius of 5 mm and spiraled outward to a radius of 20 mm at a traverse speed of 0.05 m/s for a total spiral time of 14 seconds. Before the traverse speed reached zero, the servo motor rpm dropped to zero. The robot then lifted the polishing pad away from the surface of the painted panel.

The residual polishing compound on the painted panel surface was wiped away using a wiping cloth (3M Detailing Cloth 39016, 3M Company, St. Paul, MN). The resultant polished surface was analyzed using the system illustrated and described in U.S. Provisional Patent Application No. 63/363,056, filed on Apr. 15, 2022. The haze values were calculated as described using the equation above, and are shown in FIG. 5A-1, “0 rpm step”.

### Example 2B: Liftoff

An industrial robot arm was fitted at the end of arm with 3M active compliant tool (6530, 3M Company, St. Paul, MN) and a 3M servo random orbital buffer motor (77540, 3M Company, St. Paul, MN) The buffer motor was attached directly to the active compliant tool. A back up pad (20350, 3M Company, St. Paul, MN) was attached to the end of the servo motor. A polishing pad (28874, 3M Company, St. Paul, MN) was attached to the end of the back up pad. A painted panel (57080 black painted panel, ACT Test Panels LLC, Hillsdale, MI) was placed on a table approximately 125 mm from the polishing pad.

Approximately 0.3 g of polishing compound (K211 polishing compound, 3M Company, St. Paul, MN) was placed on the painted panel directly below the polishing pad. A planned pathway was sent from a computer to the robot. The polishing pad was pressed down onto the panel with 25N of downward force. The servo motor was spun up to 8500 rpm while simultaneously beginning a spiral movement in the X-Y plane of the painted panel. The spiral began at a radius of 5 mm and spiraled outward to a radius of 20 mm at a traverse speed of 0.05 m/s. After 12.5 seconds of spiraling, the robot lifted the polishing pad off the surface of the painted panel. Spiraling continued above the surface of the painted panel for 1.5 seconds, and then the servo motor rpm dropped to zero.

The residual polishing compound on the painted panel surface was wiped away using a wiping cloth (3M Detailing Cloth 39016, 3M Company, St. Paul, MN). The resultant polished surface was analyzed using the system illustrated and described in U.S. Provisional Patent Application No. 63/363,056, filed on Apr. 15, 2022. The haze values were calculated as described using the equation above, and are shown in FIG. 5A-1, “Liftoff.”

### Example 2C: Liftoff and Reduction to ORPM with K211

An industrial robot arm was fitted at the end of arm with 3M active compliant tool (6530, 3M Company, St. Paul, MN) and a 3M servo random orbital buffer motor (77540, 3M Company, St. Paul, MN) The buffer motor was attached directly to the active compliant tool. A back up pad (20350, 3M Company, St. Paul, MN) was attached to the end of the servo motor. A polishing pad (28874, 3M Company, St. Paul, MN) was attached to the end of the back up pad. A painted panel (57080 black painted panel, ACT Test Panels LLC, Hillsdale, MI) was placed on a table approximately 125 mm from the polishing pad.

Approximately 0.3 g of polishing compound (K211 polishing compound, 3M Company, St. Paul, MN) was placed on the painted panel directly below the polishing pad. A planned pathway was sent from a computer to the robot. The polishing pad was pressed down onto the panel with 25N of downward force. The servo motor was spun up to 8500 rpm while simultaneously beginning a spiral movement in the X-Y plane of the painted panel. The spiral began at a radius of 5 mm and spiraled outward to a radius of 20 mm at a traverse speed of 0.05 m/s. After 12.2 seconds, the servo motor rpm was commanded to zero. The motor rpm decelerated to approximately 4250 rpm and then the robot lifted the polishing pad off the surface of the painted panel at approximately 12.5 seconds. Spiraling continued above the surface of the painted panel for 1.5 seconds.

The residual polishing compound on the painted panel surface was wiped away using a wiping cloth (3M Detailing Cloth 39016, 3M Company, St. Paul, MN). The resultant polished surface was analyzed using the system illustrated and described in U.S. Provisional Patent Application No. 63/363,056, filed on Apr. 15, 2022. The haze values were calculated as described using the equation above, and are shown in FIG. 5B-1, “K211” column.

### Example 2D: Combination of Liftoff and Reduction to 0 rpm with 315 Polish

An industrial robot arm was fitted at the end of arm with 3M active compliant tool (6530, 3M Company, St. Paul, MN) and a 3M servo random orbital buffer motor (77540, 3M Company, St. Paul, MN) The buffer motor was attached directly to the active compliant tool. A back up pad (20350, 3M Company, St. Paul, MN) was attached to the end of the servo motor. A polishing pad (28874, 3M Company, St. Paul, MN) was attached to the end of the back up pad. A painted panel (57080 black painted panel, ACT Test Panels LLC, Hillsdale, MI) was placed on a table approximately 125 mm from the polishing pad.

Approximately 0.3 g of polishing compound (315 polishing compound, 3M Company, St. Paul, MN) was placed on the painted panel directly below the polishing pad. A planned pathway was sent from a computer to the robot. The polishing pad was pressed down onto the panel with 25N of downward force. The servo motor was spun up to 8500 rpm while simultaneously beginning a spiral movement in the X-Y plane of the painted panel. The spiral began at a radius of 5 mm and spiraled outward to a radius of 20 mm at a traverse speed of 0.05 m/s. After 12.2 seconds, the servo motor rpm was commanded to zero. The motor rpm decelerated to approximately 4250 rpm and then the robot lifted the polishing pad off the surface of the painted panel at approximately 12.5 seconds. Spiraling continued above the surface of the painted panel for 1.5 seconds.

The residual polishing compound on the painted panel surface was wiped away using a wiping cloth (3M Detailing Cloth 39016, 3M Company, St. Paul, MN). The resultant polished surface was analyzed using the system illustrated and described in U.S. Provisional Patent Application No. 63/363,056, filed on Apr. 15, 2022. The haze values were calculated as described using the equation above, and are shown in FIG. 5B-1, “315” column.

1. A method of repairing a defect on a surface, the method comprising:
imaging the surface to locate the defect with an imaging system;
selecting a first abrasive trajectory, for a first abrasive operation, based on an indication from the imaging system;
conducting the first abrasive operation by contacting the surface with a first abrasive article, wherein the first abrasive article is pressed into contact with the surface in an area of the defect by a robotic repair system;
selecting a second trajectory for a second abrasive operation, wherein the second abrasive operation comprises contacting the surface with a second abrasive article in an area of the abraded surface, and wherein the second trajectory comprises one of:
a reduction in speed, from a next-to-last speed to an endpoint speed, wherein the reduction is by at least 90%, wherein the first and second speeds are a rotational speed, an orbital speed, or a random orbital speed, of the abrasive article, before the trajectory endpoint is reached; or
a reduction in applied force, from a next-to-last applied force to an endpoint applied force applied force, by at least 90% before the trajectory endpoint is reached; and
actuating the robotic repair unit to execute the second trajectory.

2. The method of claim 1, wherein selecting the second trajectory comprises:
retrieving a default abrasive trajectory;
identifying an amount of haze using a second imaging system;
generating a surface appearance modification for the default abrasive trajectory, based on the amount of haze;
calculating a path length required to execute the surface appearance modification such that the surface modification is executed before the trajectory reaches an endpoint; and
generating the second trajectory by modifying the abrasive trajectory to include the surface appearance modification.

3. The method of claim 2, wherein the surface appearance modification is selected from the group consisting of:
a rotational speed reduction of the second abrasive article when in contact with the surface;
an orbital speed reduction of the second abrasive article when in contact with the surface;
a random orbital speed reduction of the second abrasive article when in contact with the surface;
a vibrational rate of the second abrasive article when in contact with the surface;
an applied force on the second abrasive article when in contact with the surface; and
a z-axis position of an end-of arm of the robotic repair system with respect to the surface.

4. The method of claim 1, wherein, before the endpoint, the rotational speed is reduced to zero, the orbital speed is reduced to zero or the random orbital speed is reduced to zero.

5. The method of claim 1, wherein the applied force and/or the z-axis position is reduced such that the abrasive article decouples from the surface prior to the endpoint.

6. The method of claim 1, wherein the second imaging system is the first imaging system.

7. The method of claim 1, wherein the first imaging system is positioned on a robotic arm of the robotic repair system.

8. The method of claim 1, wherein the first abrasive article is a sanding disc and the second abrasive article is a polishing pad.

9. A method of modifying a surface appearance of a reflective surface, the method comprising:
contacting an abrasive article to the reflective surface;
moving the abrasive article along the reflective surface, wherein moving comprises a robotic arm moving the abrasive article traveling at a translational speed, with an applied force, from a starting point to an ending point; and
wherein, before reaching the ending point, a movement speed relative to the robotic arm is reduced by more than 50%.

10. The method of claim 9, wherein the movement speed is a rotational speed, an orbital speed, a random orbital speed or a vibrational speed.

11. The method of claim 9, wherein the movement speed is reduced by more than 90%.

12. The method of claim 9, wherein the movement speed is reduced by more than 95%.

13. The method of claim 9, wherein the movement speed is reduced by more than 99%.

14. The method of claim 9, wherein, before reaching the end point, an effective force by the robot arm on the abrasive article is reduced by more than 50%.

15. The method of claim 14, wherein the effective force is an applied force generated by a force control unit.

16. The method of claim 14, wherein the effective force is generated by a change in position of the robot arm with respect to the reflective surface.

17. The method of claim 14, wherein the effective force is reduced by more than 90%.

18. The method of claim 14, wherein the effective force value is reduced to a negative value.

19. A method of modifying a surface appearance of a reflective surface, the method comprising:
contacting an abrasive article to the reflective surface;
moving the abrasive article along the reflective surface, wherein moving comprises a robotic arm moving the abrasive article traveling at a translational speed, with an applied force, from a starting point to an ending point; and
wherein, before reaching the ending point, an effective force on the abrasive article, by the robotic arm, is reduced by more than 50%.

20. The method of claim 19, wherein the effective force is an applied force generated by a force control unit.

21. The method of claim 19, wherein the effective force is generated by a change in position of the robot arm with respect to the reflective surface.

22. The method of claim 19, wherein the effective force is reduced by more than 90%.

23. The method of claim 19, wherein the effective force value is reduced to a negative value.

24. The method of claim 19, wherein the effective force is reduced below 5 Newtons.

25. The method of claim 19, wherein, before reaching the end point, a relative speed of the abrasive article with respect to the robot arm is reduced by more than 50%.

26. The method of claim 25, wherein the movement speed is a rotational speed, an orbital speed, a random orbital speed or a vibrational speed.

27. The method of claim 25, wherein the movement speed is reduced by more than 90%.

28. The method of claim 25, wherein the movement speed is reduced by more than 95%.

29. The method of claim 25, wherein the movement speed is reduced by more than 99%.

30-40. (canceled)
